(19) United States
(12) Patent Application Publication
(10) Pub. No.: US 2016/0294044 A1
(43) Pub. Date: Oct. 6, 2016

(54) HEADLIGHT-MOUNTED WIRE-FORMED ANTENNA

(71) Applicant: YI CHANG HSIANG INDUSTRIAL CO., LTD., TAOYUAN CITY (TW)

(72) Inventor: CHIH-YUAN HSUEH, PA TEH CITY (TW)

(21) Appl. No.: 14/676,893

(22) Filed: Apr. 2, 2015

(51) Int. Cl. H01Q 1/32; B60Q 1/00

(52) U.S. Cl. CPC H01Q 1/3291; B60Q 1/0017

(57) ABSTRACT

A headlight-mounted wire-formed antenna includes a horizontally polarized antenna section for mounting to a transverse outer edge of a vehicle headlight, a vertically polarized antenna section for mounting to a longitudinal outer edge of the headlight, and a feeding section connected to between the horizontally polarized antenna section and the vertically polarized antenna section for mounting to an outer corner of the headlight. With these arrangements, the headlight-mounted wire-formed antenna is easy to mount and can also be integrated into a pre-assembling process of the headlight to receive different types of signals and ensure good quality of the received signals.

### FIELD OF TECHNOLOGY

The present invention relates to a headlight-mounted wire-formed antenna, and more particularly, to a headlight-mounted wire-formed antenna that is easy to mount and can also be integrated into a pre-assembling process of a vehicle headlight to receive different types of signals and ensure good quality of the received signals.

### BACKGROUND

To satisfy most drivers' requirements, most of the modern cars now have various types of electronic devices mounted therein, such as, for example, a digital television (DTV), a global positioning system (GPS), a radio, a digital audio broadcasting (DAB), and even a new-generation long-term evolution (LTE) supported wireless mobile broadband device. All of these electronic devices require an antenna to transmit and receive signals. However, the antennas for these electronic devices are not always the same in their polarization directions. Therefore, these antennas are usually mounted on the car at different positions, which causes inconvenience in antenna mounting and difficulty in integrating the antennas into a pre-assembling process of the car. For example, the radio's antenna is preferably mounted on the car's roof for ideally receiving a vertically polarized wave and the DTV's antenna is preferably mounted to the car's tail for ideally receiving a horizontally polarized wave. Furthermore, these antennas are usually mounted in different ways and the mounting thereof requires an experienced technician to ensure good signal receiving quality.

It is therefore tried by the inventor to develop a headlight-mounted wire-formed antenna that is easy to mount and can also be integrated into a pre-assembling process of a vehicle headlight to receive different types of signals and ensure good quality of the received signals.

### SUMMARY

A primary object of the present invention is to overcome the disadvantages of the prior art antenna for vehicles by providing a headlight-mounted wire-formed antenna, which is easy to mount and can also be integrated into a pre-assembling process of a vehicle headlight for receiving different types of signals and ensuring the quality of the received signals.

To achieve the above and other objects, the headlight-mounted wire-formed antenna according to a preferred embodiment of the present invention includes a horizontally polarized antenna section for mounting to a transverse outer edge of a vehicle headlight, a vertically polarized antenna section for mounting to a longitudinal outer edge of the headlight, and a feeding section connected to between the horizontally polarized antenna section and the vertically polarized antenna section for mounting to an outer corner of the headlight.

In the headlight-mounted wire-formed antenna of the present invention, the horizontally polarized antenna section can be adhered to, electroplated to or insert-molded in the headlight along the transverse outer edge thereof; the vertically polarized antenna section can be adhered to, electroplated to or insert-molded in the headlight along the longitudinal outer edge thereof; and the feeding section is mounted along the outer corner of the headlight.

More specifically, in the present invention, the horizontally polarized antenna section can be adhered to, electroplated to or insert-molded in an outer side or an inner side of a lens of the headlight or an inner side of a reflector of the headlight along the transverse outer edge of the headlight; the vertically polarized antenna section can be adhered to, electroplated to or insert-molded in the outer side or the inner side of the lens of the headlight or the inner side of the reflector of the headlight along the longitudinal outer edge of the headlight; and the feeding section can be mounted to the outer side or the inner side of the lens of the headlight or the inner side of the reflector of the headlight to locate at the outer corner of the headlight.

According to a preferred embodiment of the present invention, the headlight-mounted wire-formed antenna can further include a clear film tape set, which includes a horizontal clear film tape for adhering the horizontally polarized antenna section to the headlight along the transverse outer edge thereof and a vertical clear film tape for adhering the vertically polarized antenna section to the headlight along the longitudinal outer edge thereof.

More specifically, the horizontal clear film tape adheres the horizontally polarized antenna section to the outer side or the inner side of the lens of the headlight or to the inner side of the reflector of the headlight along the transverse outer edge of the headlight, and the vertical clear film tape adheres the vertically polarized antenna section to the outer side or the inner side of the lens of the headlight or the inner side of the reflector of the headlight along the longitudinal outer edge of the headlight.

The clear film tape may further include a corner clear film tape connected to between the horizontally polarized antenna section and the vertically polarized antenna section for adhering the feeding section to the outer corner of the headlight.

More specifically, the corner clear film tape adheres the feeding section to the outer side or the inner side of the lens of the headlight or to the inner side of the reflector of the headlight for the feeding section to locate at the outer corner of the headlight.

Alternatively, the horizontal clear film tape, the corner clear film tape and the vertical clear film tape can be integrally formed to provide the clear film tape set.

With the above arrangements, the headlight-mounted wire-formed antenna of the present invention is easy to mount and can also be integrated into a pre-assembling process of the vehicle headlight for receiving different types of signals and ensuring the quality of the received signals.

### BRIEF DESCRIPTION

The structure and the technical means adopted by the present invention to achieve the above and other objects can be best understood by referring to the following detailed description of the preferred embodiments and the accompanying drawings, wherein

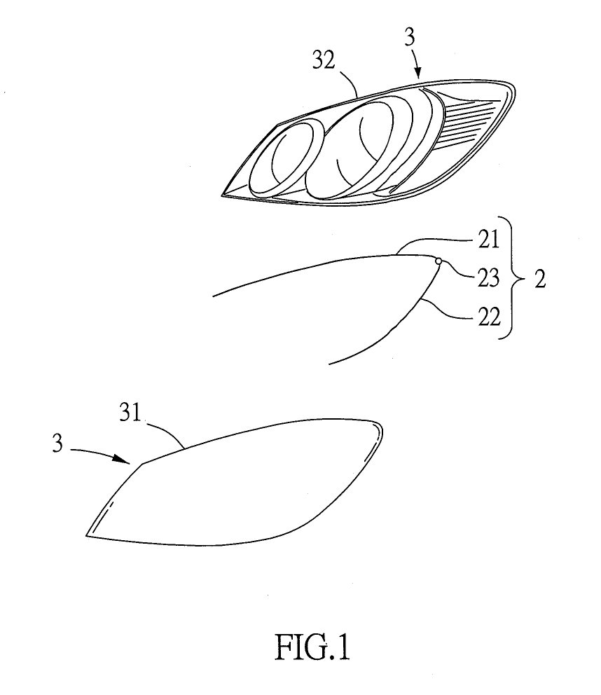

FIG. 1 is an exploded perspective view of a headlight-mounted wire-formed antenna according to a preferred embodiment of the present invention;

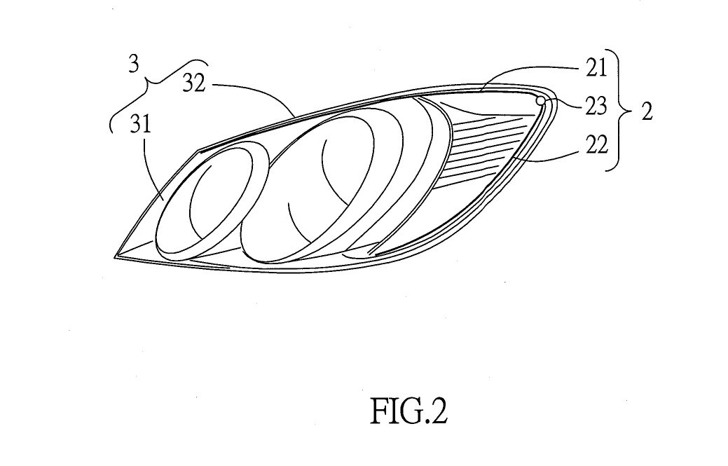

FIG. 2 is an assembled view of FIG. 1;

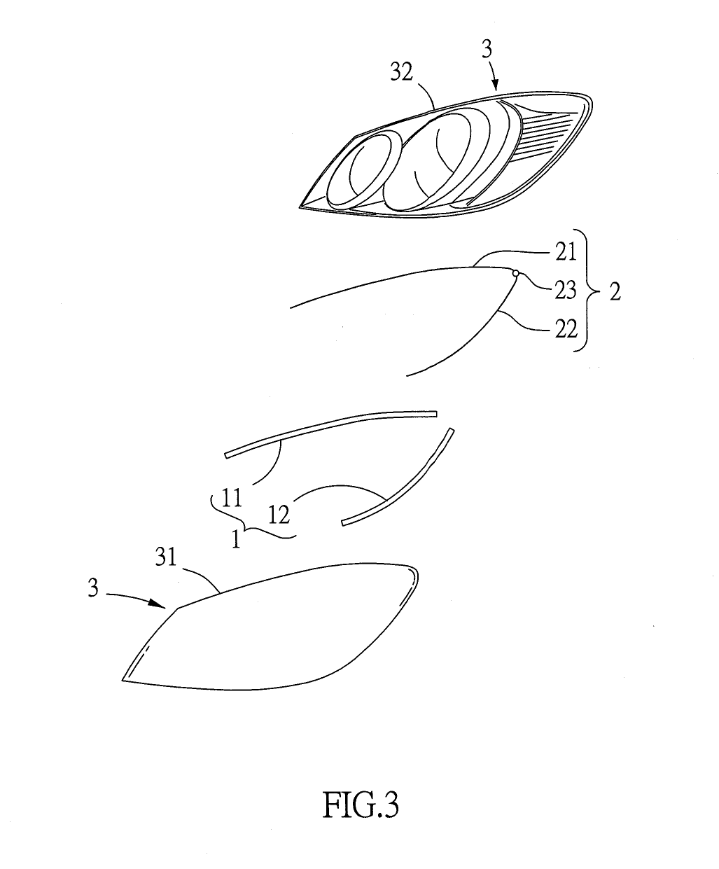

FIG. 3 is an exploded perspective view showing a clear film tape set is further included in the headlight-mounted wire-formed antenna according to the preferred embodiment of the present invention;

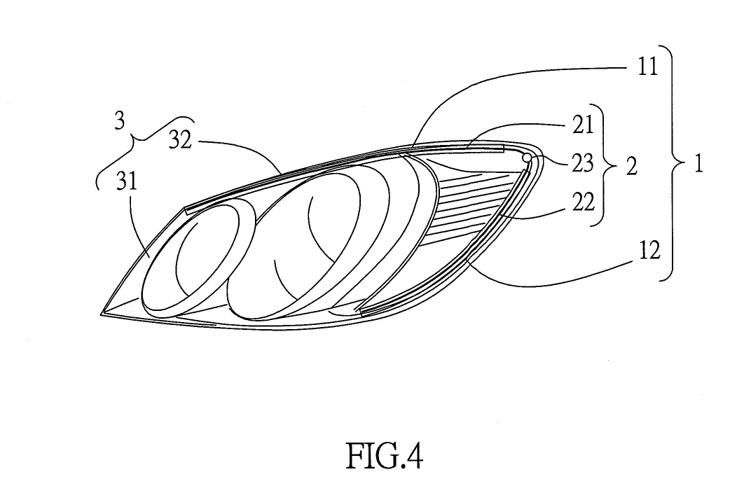

FIG. 4 is an assembled view of FIG. 3;

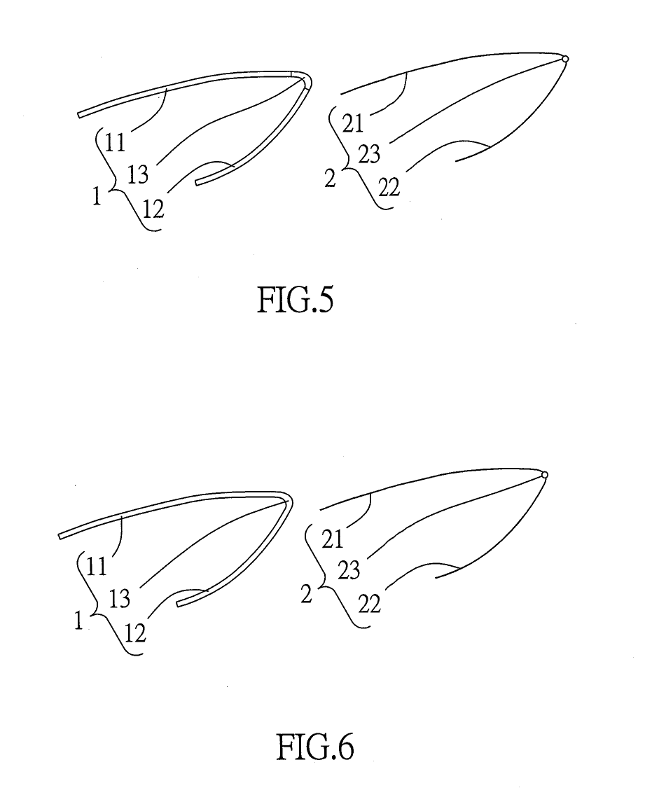

FIG. 5 shows the clear film tape set for the headlight-mounted wire-formed antenna of the present invention may include a horizontal, a corner and a vertical clear film tape; and

FIG. 6 shows the horizontal, corner and vertical clear film tapes of the clear film tape set for the headlight-mounted wire-formed antenna of the present invention may be integrally formed.

### DETAILED DESCRIPTION

The present invention will now be described with some preferred embodiments thereof and by referring to the accompanying drawings. For the purpose of easy to understand, elements that are the same in the preferred embodiments are denoted by the same reference numerals.

Please refer to FIGS. 1 and 2. A headlight-mounted wire-formed antenna 2 according to a preferred embodiment of the present invention includes a horizontally polarized antenna section 21, a vertically polarized antenna section 22, and a feeding section 23. The horizontally polarized antenna section 21 can be formed of a copper material or silver paste, and is mounted on a vehicle's headlight 3 along a transverse outer edge thereof for receiving a horizontally polarized wave. In FIGS. 1 and 2, the horizontally polarized antenna section 21 is shown as a straight antenna structure. However, it is understood the horizontally polarized antenna section 21 can also be differently designed according to the signals to be received and thereby has other structural configurations for receiving multiple types of signals. Further, the horizontally polarized antenna section 21 is not necessarily mounted to be fully horizontal in position, but may be mounted at an angle from a horizontal line to match an inclination of the transverse outer edge of the headlight 3. The vertically polarized antenna section 22 can be formed of a copper material or silver paste, and is mounted on the headlight 3 along a longitudinal outer edge thereof for receiving a vertically polarized wave. In FIGS. 1 and 2, the vertically polarized antenna section 22 is shown as a straight antenna structure. However, it is understood the vertically polarized antenna section 22 can also be differently designed according to the signals to be received and thereby has other structural configurations for receiving multiple types of signals. Further, the vertically polarized antenna section 22 is not necessarily mounted to be fully vertical in position, but may be mounted at an angle from a vertical line to match an inclination of the longitudinal outer edge of the headlight 3. The feeding section 23 is electrically connected to between the horizontally polarized antenna section 21 and the vertically polarized antenna section 22, and is located at an outer corner of the headlight 3. The feeding section 23 can be a flat conducting juncture, such that the horizontally polarized antenna section 21 and the vertically polarized antenna section 22 can be respectively bent to any desired angle relative to the outer corner of the headlight 3.

Since both of the vertically polarized wave and the horizontally polarized wave can be received at the position of the headlight 3, the headlight-mounted wire-formed antenna 2 of the present invention is able to receive multiple types of signals. Since a wire-formed antenna can be differently designed to have various structural configurations for receiving different types of signals, the signal received via the headlight-mounted wire-formed antenna 2 of the present invention can have good signal quality. Further, the headlight-mounted wire-formed antenna 2 of the present invention can be mounted in different ways, enabling it to be easily mounted or be integrated into a pre-assembling process of a vehicle, such as a headlight manufacturing process.

As can be seen from FIGS. 1 and 2, when mounting the headlight-mounted wire-formed antenna 2, the horizontally polarized antenna section 21 can be adhered to, electroplated to or insert-molded in the headlight 3 along the transverse outer edge thereof; the vertically polarized antenna section 22 can be adhered to, electroplated to or insert-molded in the headlight 3 along the longitudinal outer edge thereof; and the feeding section 23 can be mounted to along the outer corner of the headlight 3. In this way, the headlight-mounted wire-formed antenna 2 of the present invention can also be directly formed on the headlight 3 or be easily integrated into the pre-assembling process of the headlight 3.

More particularly, as can be seen from FIGS. 1 and 2, when mounting the headlight-mounted wire-formed antenna 2, the horizontally polarized antenna section 21 can be adhered to, electroplated to or insert-molded in an outer side or an inner side of a lens 31 of the headlight 3 or an inner side of a reflector 32 of the headlight 3 along the transverse outer edge thereof; meanwhile, the vertically polarized antenna section 22 can be adhered to, electroplated to or insert-molded in the outer side or the inner side of the lens 31 of the headlight 3 or the inner side of the reflector 32 of the headlight 3 along the longitudinal outer edge thereof; and the feeding section 23 can also be mounted to the outer side or the inner side of the lens 31 of the headlight 3 or the inner side of the reflector 32 of the headlight 3 along the outer corner thereof. In this way, the headlight-mounted wire-formed antenna 2 of the present invention can be selectively mounted to different positions on the headlight 3 according to actual need in use.

Please refer to FIGS. 3 and 4. The headlight-mounted wire-formed antenna 2 according to the preferred embodiment of the present invention may further include a clear film tape set 1 consisting of a horizontal clear film tape 11 and a vertical clear film tape 12. The horizontal clear film tape 11 is provided to adhere the horizontally polarized antenna section 21 to the headlight 3 along the transverse outer edge thereof, and the vertical clear film tape 12 to adhere the vertically polarized antenna section 22 to the headlight 3 along the longitudinal outer edge thereof. It is noted the horizontal clear film tape 11 is not necessarily used to adhere the horizontally polarized antenna section 21 only to a fully horizontal position, but may also be used to adhere the horizontally polarized antenna section 21 to a position that is at an angle from a horizontal line to match an inclination of the transverse outer edge of the headlight 3. Similarly, the vertical clear film tape 12 is not necessarily used to adhere the vertically polarized antenna section 22 only to a fully vertical position, but may also be used to adhere the vertically polarized antenna section 22 to a position that is at an angle from a vertical line to match an inclination of the longitudinal outer edge of the headlight 3. In this way, the headlight-mounted wire-formed antenna 2 of the present invention can be easily formed on the headlight 3 and integrated into the pre-assembling process of the headlight 3.

More particularly, as can be seen from FIGS. 3 and 4, when mounting the headlight-mounted wire-formed antenna 2, the horizontal clear film tape 11 can be used to adhere the horizontally polarized antenna section 21 to the outer side or the inner side of the lens 31 of the headlight 3 or to the inner side of the reflector 32 of the headlight 3 along the transverse outer edge of the headlight 3, and the vertical clear film tape 12 can be used to adhere the vertically polarized antenna section 22 to the outer side or the inner side of the lens 31 of the headlight 3 or the inner side of the reflector 32 of the headlight 3 along the longitudinal outer edge of the headlight 3. In this way, the headlight-mounted wire-formed antenna 2 of the present invention can be selectively adhered to different positions on the headlight 3 according to actual need in use.

FIG. 5 shows the clear film tape set 1 for the headlight-mounted wire-formed antenna 2 of the present invention can further include a corner clear film tape 13, which is connected to between the horizontal clear film tape 11 and the vertical clear film tape 12, for adhering the feeding section 23 to the outer corner of the headlight 3. With the clear film tape set 1 shown in FIG. 5, the headlight-mounted wire-formed antenna 2 of the present invention can be completely fixed to the headlight 3 while the feeding section 23 is protectively covered by the corner clear film tape 13. Further, it is noted the corner clear film tape 13 can be designed to have different curvature to match different corner designs of the headlight 3.

Just like the horizontal and the vertical clear film tape 11, 12, the corner clear film tape 13 serves to adhere the feeding section 23 of the headlight-mounted wire-formed antenna 2 of the present invention to the outer side or the inner side of the lens 31 of the headlight 3 or the inner side of the reflector 32 of the headlight 3. In this way, the headlight-mounted wire-formed antenna 2 of the present invention can be selectively adhered to different positions on the headlight 3 according to actual need in use.

As shown in FIG. 6, the horizontal, the vertical and the corner clear film tape 11, 12, 13 for the headlight-mounted wire-formed antenna 2 of the present invention can be otherwise integrally formed to give the clear film tape set 1 a simplified structure.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A headlight-mounted wire-formed antenna, comprising:
a horizontally polarized antenna section for mounting to a vehicle's headlight along a transverse outer edge thereof;
a vertically polarized antenna section for mounting to the headlight along a longitudinal outer edge thereof; and
a feeding section connected to between the horizontally polarized antenna section and the vertically polarized antenna section for locating at an outer corner of the headlight.

2. The headlight-mounted wire-formed antenna as claimed in claim 1, wherein the horizontally polarized antenna section can be adhered to, electroplated to or insert-molded in the headlight along the transverse outer edge thereof; the vertically polarized antenna section can be adhered to, electroplated to or insert-molded in the headlight along the longitudinal outer edge thereof; and the feeding section is mounted to along the outer corner of the headlight.

3. The headlight-mounted wire-formed antenna as claimed in claim 2, wherein the horizontally polarized antenna section can be adhered to, electroplated to or insert-molded in an outer side or an inner side of a lens of the headlight or an inner side of a reflector of the headlight along the transverse outer edge of the headlight; the vertically polarized antenna section can be adhered to, electroplated to or insert-molded in the outer side or the inner side of the lens of the headlight or the inner side of the reflector of the headlight along the longitudinal outer edge of the headlight; and the feeding section can be mounted to the outer side or the inner side of the lens of the headlight or the inner side of the reflector of the headlight to locate at the outer corner of the headlight.

4. The headlight-mounted wire-formed antenna as claimed in claim 1, further comprising a clear film tape set including a horizontal clear film tape for adhering the horizontally polarized antenna section to the headlight along the transverse outer edge thereof and a vertical clear film tape for adhering the vertically polarized antenna section to the headlight along the longitudinal outer edge thereof.

5. The headlight-mounted wire-formed antenna as claimed in claim 4, wherein the horizontal clear film tape adheres the horizontally polarized antenna section to an outer side or an inner side of a lens of the headlight or to an inner side of a reflector of the headlight along the transverse outer edge of the headlight, and the vertical clear film tape adheres the vertically polarized antenna section to the outer side or the inner side of the lens of the headlight or the inner side of the reflector of the headlight along the longitudinal outer edge of the headlight.

6. The headlight-mounted wire-formed antenna as claimed in claim 4, wherein the clear film tape further includes a corner clear film tape connected to between the horizontally polarized antenna section and the vertically polarized antenna section for adhering the feeding section to the outer corner of the headlight.

7. The headlight-mounted wire-formed antenna as claimed in claim 6, wherein the corner clear film tape adheres the feeding section to an outer side or an inner side of a lens of the headlight or to an inner side of a reflector of the headlight for the feeding section to locate at the outer corner of the headlight.

8. The headlight-mounted wire-formed antenna as claimed in claim 6, wherein the horizontal clear film tape, the corner clear film tape and the vertical clear film tape are integrally formed to provide the clear film tape set.
